(19) United States
(12) Patent Application Publication
(10) Pub. No.: US 2009/0276856 A1
(43) Pub. Date: Nov. 5, 2009

(54) LICENSE MANAGEMENT FACILITY

(75) Inventors: Luigi Pichetti, Rome (IT); Marco Secchi, Rome (IT); Antonio Secomandi, Brugherio (IT); Stefano Sidoti, Rome (IT)

Correspondence Address: IBM CORP. (AUSTIN), C/O NELSON AND NELSON, 2984 E. EVERGREEN AVE., SALT LAKE CITY, UT, 84109, US

(73) Assignee: INTERNATIONAL BUSINESS MACHINES CORPORATION, Armonk, NY (US)

(21) Appl. No.: 12/236,669

(22) Filed: Sep. 24, 2008

(30) Foreign Application Priority Data
Nov. 26, 2007 (EP) EP07121555

(51) Int. Cl. G06F 21/00

(52) U.S. Cl. 726/26

(57) ABSTRACT

A method is presented for managing resource licensing. The method may include detecting an installed web server and/or application server to identify a container installation path, and identifying a resource associated with the container installation path. A resource installation path and a licensing structure may be determined for the resource. The method may further include building an application representation associating the resource installation path with the licensing structure, and determining the instances of resource use. The instances of resource use may be compared to the application representation to determine a licensing state for the resource.

### BACKGROUND OF THE INVENTION

### Description of the Related Art

License management systems are often used to determine and manage software use and licensing. License management systems typically provide information relating to use of the licensed software on customer equipment, and may also provide systems and tools to allow license-enabled development, license certificate generation, and many other aspects of software licensing.

Applications made of “static content” only are generally referred to as Web applications. These may include, for example, HTML, servlets, Java server page (“JSP”) and active server page (“ASP”). These types of Web applications do not have any components that run in the context of an application server enterprise JavaBean (“EJB”) container.

J2EE connectors (.RAR file) run in the context of an application server J2C container, and provide connectivity functions towards external subsystems, such as databases and legacy systems. The typical licensing model used by this type of application is based on the number of concurrent users allowed to use the system at any time. This may be up to one hundred users at a time, and represents about five percent of the total traffic processed by license management systems.

### SUMMARY OF THE INVENTION

Embodiments of the invention have been developed to provide a license management facility.

Some embodiments of the invention include a method for managing resource licensing. This method may include detecting an installed Web server and/or application server to identify a container installation path, and identifying a resource associated with the container installation path. A resource installation path and a licensing structure for the resource may then be determined.

The method may further include building an application representation that associates the resource installation path with the licensing structure. Instances of resource use may be determined and compared with the application representation to determine a licensing state for the resource.

A corresponding system and computer program product for implementing the above-stated method are also disclosed and claimed herein.

### BRIEF DESCRIPTION OF THE DRAWINGS

In order that the advantages of the disclosure will be readily understood, a more particular description of embodiments of the invention briefly described above will be rendered by reference to specific embodiments illustrated in the appended drawings. Understanding that these drawings depict only typical embodiments of the invention and are not therefore to be considered limiting of its scope, embodiments of the invention will be described and explained with additional specificity and detail through use of the accompanying drawings, in which:

FIG. 1 is a block diagram of a license management system in accordance with one embodiment of the invention; and

FIG. 2 is a flow chart detailing steps of a method for managing resource licensing in accordance with one embodiment of the invention.

### DETAILED DESCRIPTION OF THE INVENTION

It will be readily understood that the components of embodiments of the present invention, as generally described and illustrated in the Figures herein, may be arranged and designed in a wide variety of different configurations. Thus, the following more detailed description of the embodiments of the systems and methods of the present invention, as represented in the Figures, is not intended to limit the scope of the disclosure, as claimed, but is merely representative of selected embodiments of the invention.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that embodiments of the invention can be practiced without one or more of the specific details, or with other methods, components, etc. In other instances, well-known structures, or operations are not shown or described in detail to avoid obscuring aspects of the disclosure.

The illustrated embodiments of the invention will be best understood by reference to the drawings, wherein like parts are designated by like numerals throughout. The following description is intended only by way of example, and simply illustrates certain selected embodiments of the invention that are consistent with the disclosure as claimed herein.

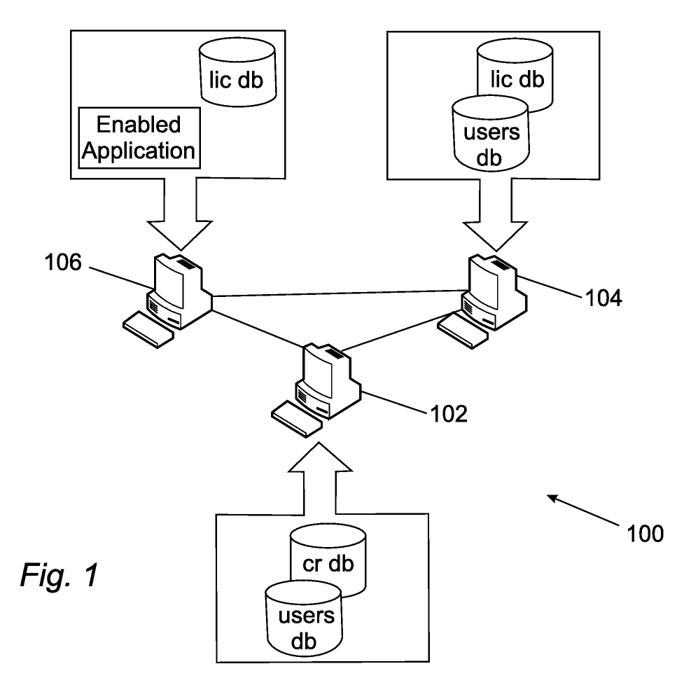

Referring now to FIG. 1, a license management system 100 may generally include a central registry license server 102 and a network license server 104. User equipment 106 may be connected to each server 102, 104. The central registry license server 102 may include a central registry database and a user database. Similarly, the network license server may include a licensed database and a user database. The user equipment 106 may operate an application. The network license server 104 may interrogate the user equipment 106 in order to determine if a suitable license is in existence for the enabled application. If the license is available, no action may be taken. If, however, there is no license available, the application may be disabled or other appropriate action taken.

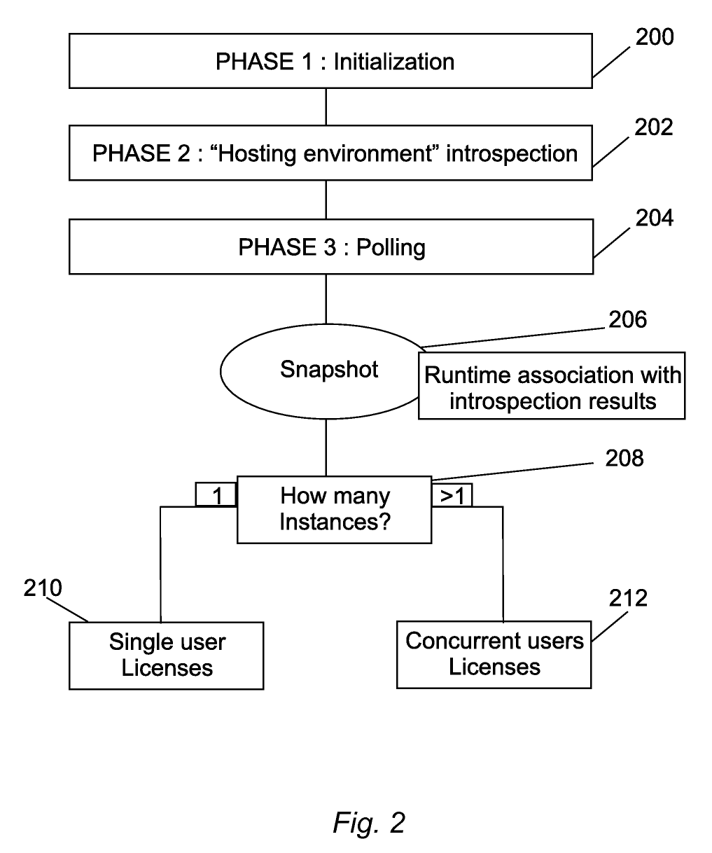

To avoid problems arising from Web applications and J2EE connectors, the present invention may use license management system agents to detect the existence of a Web server (or Web container of an application server), and perform a “hosting environment” introspective operation to discover Web applications and their configurations. The flowchart of FIG. 2 shows a high-level flow diagram of various method steps associated with one embodiment of the present invention.

Particularly, Phase 1 200 may include an initialization phase carried out by an initialization module. During the initialization phase, the license management system may detect installed Web servers and application servers by means of operating system registers, or any product-specific registry files located on the user equipment. This phase may be used to determine container installation paths (“CIP”) associated with the enabled applications.

A discovery phase (not shown) may follow, which may be carried out by a discovery module. In the discovery phase, the license management system may search for applications (application.XML), Web modules (Web.XML), and connectors (rar.XML) under each CIP. The discovery phase may parse the files and extract a resource name associated with a parent application in case of any static resources.

The discovery phase may require an understanding of composite static resources (and any other resources) available under each CIP for each application. Each resource may be identified by a list of resource installation paths (“RIP”), since a single resource may be installed in more than one path under the CIP.

Phase 2 202 may be a hosting environment introspective phase carried out by a hosting environment introspective module. Dynamic creation of the hosting environment configuration may allow the license management system to detect a number of applications deployed within the Web server or application server.

The next phase, Phase 3 204, may include a polling phase carried out by a polling module. The polling phase may enable the license management system agent to monitor the hosting environment. This may be accomplished by performing a series of “snapshots” 206 through a set of JMX API calls. In some embodiments, this may be carried out by a snapshot module.

In some embodiments, the license management system agent may retrieve information relating to the hosting runtime environment by means of a JMX interface, for example. This retrieved information may then be used to build an internal representation of resources that may be used in the licensing context. In one example, three subsets of queries are performed in a specific sequence.

The first query may relate to determining the parent level in the licensing structure, in particular for applications. The snapshot of the applications may enable identification of applications that are running in the application server and in the CIP thereof. The second and third queries may be for the Web modules and connectors, respectively, and may also enable identification of the resource names and their RIPs.

The licensing structure information built during the discovery phase may be associated with the query responses. As a result, the license management system may be able to count the instances of use for each single resource, and the total number of subresources for a particular parent resource. Since multiple users may run multiple resources, this method of associating the licensing structure information and the query responses may enable concurrent user licensing.

At step 208, a determination may be made as to how many instances of a particular type of resource or RIP are running. If there is only one instance running, only a single user license 210 may be required. However, if there is more than one instance running, a concurrent user license 212 may be required.

Some embodiments of the licensing management system of the present invention may detect if a certain servlet has been invoked to measure instances. This information may be matched against a previously-created hosting environment configuration to retrieve the associated application that is running based on each instance.

In one example, an embodiment of a license management system in accordance with the invention may monitor concurrent user-type licenses by performing a “snapshot” of J2EE applications and related connectors and Web modules. This may be determined through a set of JMX calls and string re-arrangements. The license management system may use this snapshot to identify and isolate what is running at a particular moment. This may make it possible to count the number of particular uses of an individual instance. Then by associating this count of users that are concurrently requesting and running that specific resource or instance, the system may determine the type of licenses that should be attributed to the use.

Embodiments of the present invention may not require additional instrumentation in order to monitor and manage applications and resources. Embodiments of the invention may also provide a reliable configuration and mapping of the deployed applications, and may allow the application components to be handled in a bundle. Embodiments of the invention may also be equipped to deal with an increased number of license types.

It will be appreciated that examples other than those described above may exist, which fall within the scope of the present invention. For example, the steps may take place in different orders and by different modules.

1. A method for managing resource licensing, the method comprising:
detecting at least one of an installed Web server and an installed application server to identify a container installation path;
identifying a resource associated with the container installation path;
determining a resource installation path for the resource;
determining a licensing structure for the resource;
building an application representation that associates the resource installation path with the licensing structure;
determining instances of resource use; and
comparing the instances to the application representation to determine a licensing state for the resource.

2. The method of claim 1, further comprising comparing the licensing state with a predetermined licensing state for the resource.

3. The method of claim 1, wherein detecting at least one of an installed Web server and an installed application server comprises utilizing operating system registries to detect the installed server.

4. The method of claim 1, further comprising identifying a parent application for the resource.

5. The method of claim 1, wherein determining the licensing structure comprises utilizing a series of JMX API calls.

6. The method of claim 1, wherein the resources is a static resource.

7. A system for managing resource licensing, the system comprising:
an initialization module for detecting at least one of an installed web server and an installed application server to determine a set of container installation paths;
a discovery module for determining a resource associated with each container installation path and a resource installation path for the resource;
a determination module for determining a licensing structure for the resource;
a polling module for building an application representation associating the resource installation path with the licensing structure and determining instances of resource use; and
a comparator for comparing the instances to the application representation to determine a licensing state for the resource.

8. The system of claim 7, wherein the comparator further compares the licensing state to a predetermined licensing state for the resource.

9. The system of claim 7, wherein the resource belongs to a parent application.

10. The system of claim 7, wherein the determination module utilizes a series of JMX API calls to determine the licensing structure.

11. The system of claim 7, wherein the resource is a static resource.

12. A computer program product for managing resource licensing, the computer program product comprising:
a computer-usable medium having computer-usable program code embodied therein, the computer-usable program code comprising:
computer-usable program code for detecting at least one of an installed Web server and an installed application server to identify a container installation path;
computer-usable program code for identifying a resource associated with the container installation path;
computer-usable program code for determining a resource installation path for the resource;
computer-usable program code for determining a licensing structure for the resource;
computer-usable program code for building an application representation that associates the resource installation path with the licensing structure;
computer-usable program code for determining instances of resource use; and
computer-usable program code for comparing the instances to the application representation to determine a licensing state for the resource.

13. The computer program product of claim 12, further comprising computer-usable program code for comparing the licensing state with a predetermined licensing state for the resource.

14. The computer program product of claim 12, wherein the computer-usable program code for detecting at least one of an installed Web server and an installed application server utilizes operating system registries to detect the installed server.

15. The computer program product of claim 12, further comprising computer-usable program code for identifying a parent application for the resource.

16. The computer program product of claim 12, wherein the computer-usable program code for determining the licensing structure utilizes a series of JMX API calls to determine the licensing structure.

17. The computer program product of claim 12, wherein the resource is a static resource.
